(19) United States
(12) Patent Application Publication
(10) Pub. No.: US 2010/0194152 A1
(43) Pub. Date: Aug. 5, 2010

(54) MOTOR VEHICLE HAVING AN A COLUMN

(75) Inventors: Peter Arndt, Ruesselsheim (DE); Olaf Kaden, Nieder-Hilbersheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/667,668

(22) PCT Filed: Apr. 28, 2008
(86) PCT No.: PCT/EP2008/003423

§ 371 Date: Jan. 4, 2010

(30) Foreign Application Priority Data
Jul. 4, 2007 (DE) 102007031074.0

(51) Int. Cl. B60H 1/00

(52) U.S. Cl. 296/208

(57) ABSTRACT

A motor vehicle is provided having an A column, which forks in its lower area into an A1 column and an A2 column, in order to accommodate a triangular window therein, having a panel enveloping the A2 column, the spatial area between A2 column and panel being implemented as a flow channel, which is connected to a fresh air supply, the panel having a first air outlet opening facing toward the triangular window and/or a second air outlet opening facing toward a side window.

### CROSS-REFERENCE TO RELATED APPLICATIONS

This application is a U.S. National-Stage entry under 35 U.S.C. §371 based on International Application No. PCT/EP2008/003423, filed Apr. 28, 2008, which was published under PCT Article 21(2) and which claims priority to German Application No. 102007031074.0, filed Jul. 4, 2007, which are all hereby incorporated in their entirety by reference.

### TECHNICAL FIELD

The invention relates to a motor vehicle having an A column, which forks in its lower area into an A1 column and an A2 column, in order to accommodate a triangular window between the A1 and A2 columns.

### BACKGROUND

In vehicles of this type, the need exists, when the triangular window is fogged on the inside and possibly the front side window is additionally fogged, to supply sufficient dry fresh air to the pane or panes to dry or deice them, in order to again obtain a clear view through them.

To solve this problem, providing nozzles in the dashboard close to the triangular windows, through which fresh air is supplied to both the triangular window and also the (front) side panes, is known in practice. Nozzles of this type, which are separate components, additionally typically also comprise lamellae, using which the flow direction of the exiting air can be set manually.

Providing a (single) nozzle in the panel associated with the A1 column, which applies air to the side pane, is known. Air is applied to the triangular window by a separate nozzle.

DE 3002134 A1 describes a passenger automobile without a triangular window, which has a triangular screen, which reduces the window cutout of the side pane. The screen has air outlet openings, through which an air stream is guided to the proximal section of the side pane.

It is at least one object of one embodiment of the invention that the panes of triangular window and side window can be dried or deiced more easily from the vehicle interior. In addition, other objects, desirable features, and characteristics will become apparent from the subsequent summary and detailed description, and the appended claims, taken in conjunction with the accompanying drawings and this background.

### SUMMARY

A first embodiment of the invention relates to a motor vehicle having an A column, which forks in its lower area into an A1 column and an A2 column, in order to accommodate a triangular window in the forked area. The A2 column has a panel which envelops it, the spatial area between the A2 column and its panel being implemented as a flow channel for fresh air, i.e., it is connected to a fresh air supply. The panel has a first air outlet opening facing toward the triangular window and a second air outlet opening facing toward a side window.

The proposed embodiment thus provides implementing the spatial area between the metal A2 column and its panel, which comprises plastic, as a flow channel, and to introduce at least one air outlet opening in the panel, using which air is applied to the triangular window and/or the side window.

The described spatial area is implemented as a flow channel by the selection of an appropriate geometry and/or shape of the panel or those parts of the panel which adjoin the flow channel. This shape is adapted to the geometry of the A2 column. It can thus not only be ensured that air can flow into the vehicle in interior through the described spatial area at all. Rather, the flow behavior of the air can also be established in relation to its direction at the at least one air outlet opening in this way. If two air outlet openings are selected, the quantity ratio of the air exiting from the two air outlet openings is established by the shape selection of the panel. In the typical case, more air is supplied to the side pane, which can belong to a drop window, than to the triangular window.

The proposed embodiment manages without a nozzle as a separate component, because the spatial area between the A2 column and its panel already predetermines the flow direction of the air flowing out of the panel through its implementation and additionally ensures that air is actually applied to the panes. Fewer parts must be kept available due to this selection. Installation of the separate nozzle is dispensed with, which reduces the production costs and saves costs. Furthermore, an opening for the nozzle no longer has to be introduced into the dashboard, so that its production is performed more rapidly and cost-effectively, particularly because a corresponding tool is no longer required for introducing the nozzle opening.

In a second embodiment, a nozzle is shaped into the panel in the area of the first and/or the second air outlet opening. The flow cross-section constricts in the area of the air outlet opening due to the nozzle, whereby the range of the air stream for drying/deicing the panes is improved and air is applied to the panes more deliberately. Nozzle and panel are integral in this case, whereby manufacturing and installation tolerances for a separate nozzle no longer play a role. Furthermore, movable lamellae for the nozzle may be dispensed with.

In a further embodiment, air conduction elements are situated in the flow channel, in particular in the area of the air outlet openings. The air conduction elements influence the flow behavior in the above-mentioned spatial area, apply a direction to the air flowing out of the air outlet openings, and thus cause air to be applied correctly to the panes.

In a further embodiment, the described air conduction elements are shaped onto the panel, and are protrusions shaped like shark fins or have the form of wall-like circular segments, above and between which the air flows, whereby a directed flow is generated, which ensures air is applied optimally to the panes of triangular window and side window upon exiting from the air outlet openings.

Furthermore, one embodiment provides that an inlay part is located between the A2 column and the panel. The inlay part, which completely envelops the metal A2 column and is optionally clipped to the panel with spacing, can be manufactured from plastic and is made of light EPDM, for example. The flow channel is defined by the spatial area between the inlay part, which is adapted to the contour of the A2 column, and the panel. The inlay part represents a thermal insulator, which prevents condensation of moisture entrained by the air on the cold metal A2 column in winter in particular. The shape selection of the inlay part determines, together with the geometry of the panel, the described flow channel, and the flow behavior of the air.

Furthermore, an embodiment is proposed in which air conduction elements are shaped onto the inlay part. The above statements apply accordingly for these air conduction elements, which may be provided alternatively or cumulatively to the air conduction elements of the panel.

Further features and advantages of the claimed invention will be recognizable from the following detailed description with reference to the appended drawings, which are specified hereafter as nonrestrictive examples. The use of reference numerals in the figures is not to be understood to mean that the reference numerals are to restrict the protective scope of the claimed invention.

### BRIEF DESCRIPTION OF THE DRAWINGS

The present invention will hereinafter be described in conjunction with the following drawing figures, wherein like numerals denote like elements, and

FIG. 1 shows a motor vehicle having an A column, which is implemented according to an embodiment of the invention,

FIG. 2 shows the A column of the motor vehicle from FIG. 1 in detail; and

FIG. 3 shows the area of the air outlet openings in the area of the A2 column.

### DETAILED DESCRIPTION

The following detailed description is merely exemplary in nature and is not intended to limit application and uses. Furthermore, there is no intention to be bound by any theory presented in the preceding background or summary or the following detailed description.

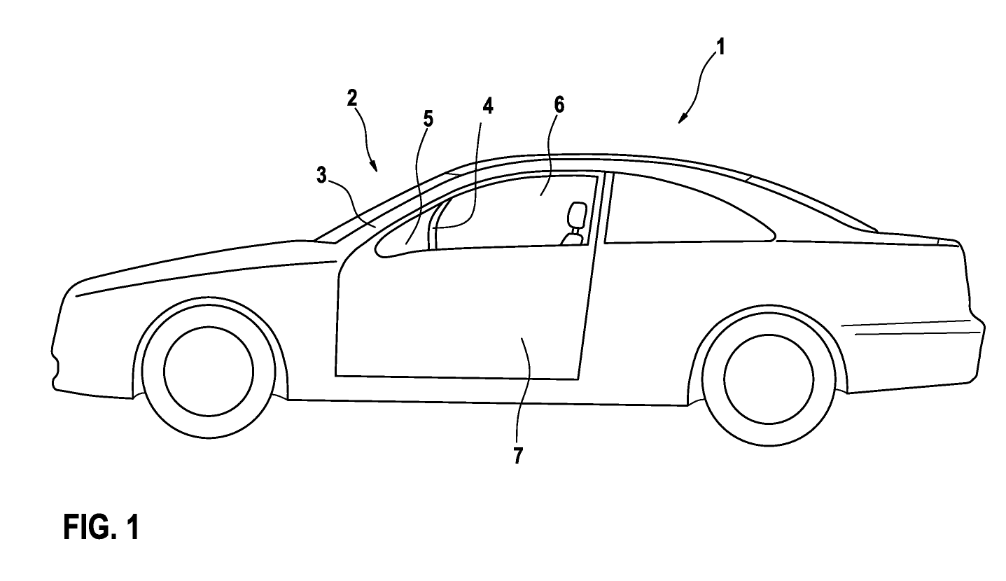

In the figures, which generally identify identical objects using identical reference numerals, FIG. 1 shows a motor vehicle 1 having an A column 2, which has an A1 column 3 and an A2 column 4. A triangular window 5 is located between the A1 and A2 columns and the front side window 6 is located adjoining the A2 column.

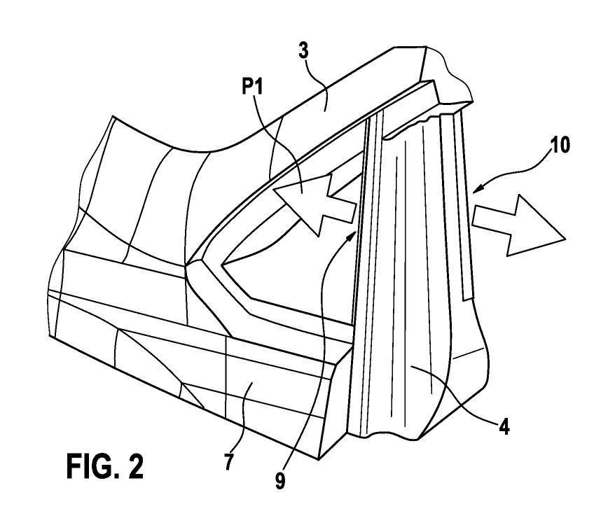

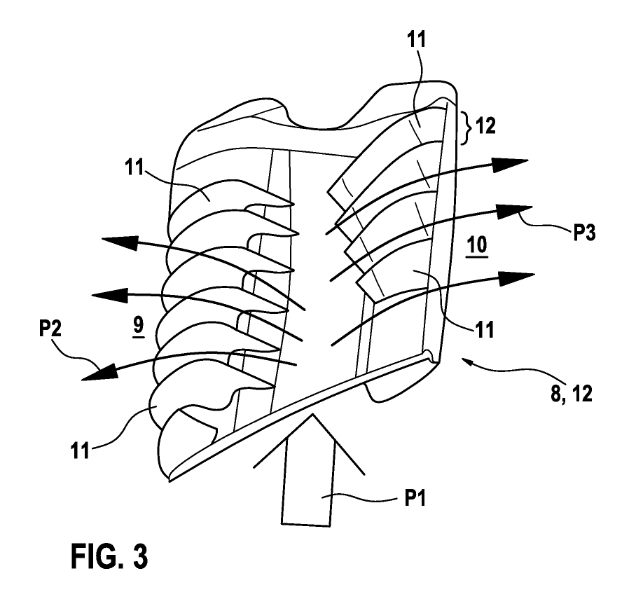

FIG. 2 shows a vehicle body area of the motor vehicle 1 in the area of the triangular window 5 above the driver door 7. The A2 column 4, which is enveloped by a plastic panel 8 (partially shown in FIG. 3), has a first air outlet opening 9 facing toward the triangular window 5, so that air flowing in the direction of the arrow P1 can be applied laterally in the direction of the arrow P2 to the pane of the triangular window 5. Furthermore, it has a second air outlet opening 10 in the form of an oblong slot, from which air can flow in the direction of the arrow P3 to the front left side window 6.

FIG. 3 partially shows the area of the air outlet openings 9, 10. A plurality of wall-like air conduction elements 11 is provided in this area, which are shaped onto either the (inner) panel 8, which is visible to the vehicle occupants, or onto a separate inlay part 12 located between the metal A2 column and the panel 12. Fresh air firstly flows upward in the direction of the arrow P1 and is then conducted laterally in the direction of the arrows P2 and P3 to the air outlet openings 9, 10, respectively, by the air conduction elements. The intermediate spaces between the air conduction elements 11 define small nozzles 12, whose number and orientation establishes the exiting air stream to the two windows 5, 6.

Although a concrete embodiment was described above, one skilled in the art will recognize that the description of this embodiment does not have the purpose of restricting the invention to the specified form. Rather, the invention is to comprise all modifications, equivalents, and alternatives which fall in the protective scope of the claimed invention. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A motor vehicle, comprising:
an A column that forks in a lower area into an A1 column and an A2 column; and
a triangular window accommodated by the A column, the triangular window comprising a panel enveloping the A2 column,
wherein a spatial area between the A2 column and the panel is implemented as a flow channel, the panel comprising a first air outlet opening facing toward the triangular window and a second air outlet opening facing toward a side window.

2. The motor vehicle according to claim 1, wherein a nozzle is shaped into the panel in the area of the first air outlet opening.

3. The motor vehicle according to claim 1, further comprising air conduction elements situated in the flow channel.

4. The motor vehicle according to claim 1, wherein the air conduction elements are shaped onto the panel.

5. The motor vehicle according to claim 1, further comprising an inlay part is located between the A2 column and the panel.

6. The motor vehicle according to claim 5, wherein the air conduction elements are shaped onto the inlay part.

7. The motor vehicle according to claim 5, wherein the inlay part is manufactured from EPDM.

8. The motor vehicle according to claim 1, wherein a nozzle is shaped into the panel in the area of the second air outlet opening.
